(19) United States
(12) Patent Application Publication
(10) Pub. No.: US 2022/0076191 A1
(43) Pub. Date: Mar. 10, 2022

(54) ORDER DELIVERY METHODS AND ELECTRONIC DEVICES, DELIVERY ROBOTS AND TRANSFER SYSTEMS

(71) Applicant: Rajax Network & Technology (Shanghai) Co., Ltd., Shanghai (CN)

(72) Inventors: Kai WANG, Shanghai (CN); Wei MIN, Shanghai (CN); Pei LI, Shanghai (CN); Huitao HAO, Shanghai (CN); Xinyu DAI, Shanghai (CN)

(21) Appl. No.: 17/413,546

(22) PCT Filed: Dec. 10, 2019
(86) PCT No.: PCT/CN2019/124295

§ 371 Date: Jun. 12, 2021

(30) Foreign Application Priority Data
Dec. 13, 2018 (CN) 201811524732.5

(51) Int. Cl. G06Q 10/08

(52) U.S. Cl. CPC G06Q 10/083; G05B 19/4155

(57) ABSTRACT

Provided are an order delivery method, an electronic device, a delivery robot and a transfer system. The delivery robot includes a moving and storage system, an interaction apparatus and a control apparatus. The transfer system includes at least one storage bin, a transfer mechanism, an interaction apparatus and a control apparatus. The electronic device is configured to perform the order delivery method, including: obtaining an order set and status information of a delivery robot, and determining a delivery mode of the delivery robot for an in-delivery order according to the order set and the status information of the delivery robot. In these examples, the transfer or delivery of an order can be achieved by interaction of the delivery robot, the transfer system and the electronic device, thereby improving the efficiency of a delivery process.

This application claims priority to Chinese Patent Application No. 201811524732.5, titled “ORDER DELIVERY METHODS AND ELECTRONIC DEVICES, DELIVERY ROBOTS AND TRANSFER SYSTEMS”, filed on Dec. 13, 2018, the contents of all of which are incorporated herein by reference.

### TECHNICAL FIELD

The present disclosure relates to the field of electronic technology, and in particular to an order delivery method, an electronic device, a delivery robot and a transfer system.

### BACKGROUND

Along with continuous development of science and technology, order delivery modes in the electronic commerce industry become more and more diversified, and, for example, maybe delivery modes based on unmanned aerial vehicles and delivery robots and so on. Generally, for the delivery mode based on delivery robots, a delivery robot is provided in a predetermined region, and an order delivery man (i.e. a delivery man) only needs to place one or more orders into a storage bin of the delivery robot. After the storage bin is full, the delivery robot will immediately start delivery. When there is any vacant position in the storage bin, the delivery robot will wait for a period of time before starting delivery. Sometimes, the delivery man may have to wait for a long period of time before the delivery robot completes delivery and returns to a handover position within the predetermined region and then hand over one or more orders to be delivered to the delivery robot; in some cases, the delivery robot may need to spend a long period of time waiting for a user to pick up an order (e.g. take a meal), which both will result in low efficiency of a delivery process, thereby increasing the delivery costs of the delivery robot.

### SUMMARY

In view of this, examples of the present disclosure provide an order delivery method, an electronic device, a delivery robot, and a transfer system, which can improve the efficiency of a delivery process and reduce the delivery costs of a delivery robot.

According to a first aspect, examples of the present disclosure provides an order delivery method, applied to delivery of a delivery object by an automatic delivery system comprising a delivery robot and a transfer system, includes:

obtaining an order set, where a target address of each order in the order set is within a predetermined region, and the order is an order to be handed over to the automatic delivery system;

obtaining status information of the delivery robot, where the status information of the delivery robot includes an in-delivery order and a current position of the delivery robot; and

determining a delivery mode of the delivery robot for the in-delivery order according to the order set and the status information of the delivery robot, where the delivery mode includes transferring the delivery object through the transfer system, or moving to the target address of the order for direct delivery.

Determining the delivery mode of the delivery robot for the in-delivery order according to the order set and the status information of the delivery robot includes:

determining the delivery mode of each delivery robot for the in-delivery order according to the order set and the status information of each delivery robot.

In some examples, the method further includes:

obtaining an elevator status of the predetermined region; and

determining the delivery mode of the delivery robot for the in-delivery order according to the order set and the status information of the delivery robot, including:

determining a target delivery plan according to the target address of the in-delivery order, one or more target addresses of the order set, the status information of the delivery robot and the elevator status; and

determining the delivery mode of the delivery robot for the in-delivery order according to the target delivery plan.

In some examples, the status information of the delivery robot further includes a number of current vacant bins, and the elevator status includes a current position of an elevator, a number of floors where the elevator is to stay, one or more floors where the elevator is to stay and a running status.

Determining the target delivery plan according to the target address of the in-delivery order, the one or more target addresses of the order set, the status information of the delivery robot and the elevator status includes:

determining the target delivery plan according to the target address of the in-delivery order, the one or more target addresses of the order set, the status information of the delivery robot, the current position of the elevator, the number of floors where the elevator is to stay, the one or more floors where the elevator is to stay and the running status.

According to a second aspect, examples of the present disclosure provide a computer-readable storage medium, storing computer program instructions, where the computer program instructions are executed by a processor to perform the method according to the first aspect.

According to a third aspect, examples of the present disclosure provides an electronic device, including a memory and a processor, where the memory is used to store one or more computer program instructions, and the one or more computer program instructions are executed by the processor to:

obtaining an order set, where a target address of each order in the order set is within a predetermined region and the order is an order to be handed over to an automatic delivery system;

obtaining status information of a delivery robot, where the status information of the delivery robot includes an in-delivery order and a current position of the delivery robot;

determining a delivery mode of the delivery robot for the in-delivery order according to the order set and the status information of the delivery robot, where the delivery mode includes transferring a delivery object through a transfer system, or moving to the target address of the order for direct delivery.

In some examples, determining the delivery mode of the delivery robot for the in-delivery order according to the order set and the status information of the delivery robot includes:

determining the delivery mode of each delivery robot for the in-delivery order according to the order set and the status information of each delivery robot.

In some examples, the electronic device is further configured to:

obtain an elevator status of the predetermined region; and

determine the delivery mode of the delivery robot for the in-delivery order according to the order set and the status information of the delivery robot, including:

determine a target delivery plan according to the target address of the in-delivery order, one or more target addresses of the order set, the status information of the delivery robot and the elevator status; and

determine the delivery mode of the delivery robot for the in-delivery order according to the target delivery plan.

In some examples, the status information of the delivery robot further includes a number of current vacant bins, and the elevator status includes a current position of an elevator, a number of floors where the elevator is to stay, one or more floors where the elevator is to stay and a running status.

Determining the target delivery plan according to the target address of the in-delivery order, the one or more target addresses of the order set, the status information of the delivery robot and the elevator status includes:

determining the target delivery plan according to the target address of the in-delivery order, the one or more target addresses of the order set, the status information of the delivery robot, the current position of the elevator, the number of floors where the elevator is to stay, the one or more floors where the elevator is to stay and the running status.

According to a fourth aspect, examples of the present disclosure provides a delivery robot, including:

a moving and storage system, configured to drive the delivery robot to move and be controlled to open or close at least one storage bin for taking and placing a delivery object;

an interaction apparatus, configured to perform information interaction; and

a control apparatus, configured to control the moving and storage system to move to a handover-for-transfer position corresponding to an order for transferring a delivery object, or move to a target address of the order for direct delivery of the delivery object.

In some examples, the control apparatus is configured to control the moving and storage system to move to the handover-for-transfer position for transferring the delivery object in response to receiving a transfer instruction.

In some examples, the control apparatus is configured to control the moving and storage system to move to the handover-for-transfer position for transferring the delivery object in response to that an allocated order queue satisfies a preset condition.

In some examples, the preset condition is that a length of the order queue exceeds a first threshold.

According to a fifth aspect, examples of the present disclosure provides a transfer system, including:

at least one storage bin, where the storage bin each includes a storage space and a first unit door and a second unit door both closing the storage space, and the first unit door and the second unit door are oppositely disposed;

a transfer mechanism, disposed at a side of the at least one storage bin on which the second unit door is provided, and configured to be controlled to transfer a delivery object between the at least one storage bin and a handover-for-transfer position;

an interaction apparatus, configured to receive and send an instruction;

a control apparatus, configured to control the first unit door and the second unit door of the at least one storage bin and the transfer mechanism;

where the control apparatus is configured to, in response to that the interaction apparatus receives a first placing instruction, select one vacant storage bin, control the second unit door of the vacant storage bin to open, and control the transfer mechanism to transfer a delivery object into the storage bin from the handover-for-transfer position.

In some examples, the transfer mechanism includes:

a base, provided with a guiderail extending along a first direction to the handover-for-transfer position;

a rotary seat, disposed on a first shaft and configured to move along the first direction on the guiderail and rotate with a second direction as an axial direction;

a lifting apparatus, disposed on the rotary seat and the first shaft and configured to move along a third direction on the first shaft;

a retractable apparatus, disposed on the lifting apparatus and configured to move along a fourth direction;

a taking-and-placing component, connected to the retractable apparatus to perform taking or placing operations along with movement of the retractable apparatus.

In some examples, the transfer system further includes a tray that is disposed in the storage bin.

The taking-and-placing component includes an operation arm for taking and placing the tray.

In some examples, the control apparatus is configured to, in response to that the interaction apparatus receives a first taking instruction, control the first unit door of the storage bin corresponding to the first taking instruction to open.

In some examples, the control apparatus is configured to select one vacant storage bin and control a first unit door of the vacant storage bin to open in response to a second placing instruction.

In some examples, the control apparatus is configured to, in response to that the interaction apparatus receives a second taking instruction, control a second unit door of a storage bin corresponding to the second taking instruction to open and control the transfer mechanism to take the delivery object out of the storage bin and transfer the delivery object to the handover-for-transfer position.

In some examples, the interaction apparatus performs interaction through wireless communication and/or by scanning a computer-recognizable pattern.

In examples of the present disclosure, an order delivery method, an electronic device, a delivery robot and a transfer system are provided. The delivery robot includes a moving and storage system, an interaction apparatus and a control apparatus. The transfer system includes at least one storage bin, a transfer mechanism, an interaction apparatus and a control apparatus. The electronic device is configured to perform the order delivery method, including obtaining an order set and status information of a delivery robot, and determining a delivery mode of the delivery robot for an in-delivery order according to the order set and the status information of the delivery robot. In these examples, an order can be transferred or delivered through interaction of the delivery robot, the transfer system and the electronic device, thereby improving the efficiency of a delivery process.

### BRIEF DESCRIPTION OF THE DRAWINGS

To make the above descriptions, and other objects, features and advantages of the present disclosure clearer, examples of the present disclosure will be detailed below by referring to the accompanying drawings.

FIG. 1 is a diagram of a system architecture of examples of the present disclosure.

FIG. 2 is a schematic diagram of an automatic delivery system according to a first example of the present disclosure.

FIG. 3 is a structural block diagram of a delivery robot according to a second example of the present disclosure.

FIG. 4 is a schematic diagram of a transfer system according to a third example of the present disclosure.

FIG. 5 is a side view of a storage bin of the transfer system according to the third example of the present disclosure.

FIG. 6 is a schematic diagram of a transfer apparatus according to the third example of the present disclosure.

FIG. 7 is a flowchart of an order delivery method according to a fourth example of the present disclosure.

FIG. 8 is a schematic diagram of an interface according to the fourth example of the present disclosure.

FIG. 9 is a flowchart of an order delivery method according to a fifth example of the present disclosure.

FIG. 10 is a diagram of an application scenario according to the fifth example of the present disclosure.

FIG. 11 is a schematic diagram of an electronic device according to the fifth example of the present disclosure.

### DETAILED DESCRIPTION OF THE EMBODIMENTS

The present disclosure is described based on the examples but is not limited to these examples. Some specific parts are detailed below in the detailed descriptions of the present disclosure. Those skilled in the art may fully understand the present disclosure even without these specific parts. To avoid confusion of the essence of the present disclosure, the well-known methods, processes, flows, elements and circuits are not detailed herein.

Furthermore, those skilled in the art shall understand that the accompanying drawings herein are used for the purpose of descriptions and not necessarily drawn to scale.

Unless otherwise stated in the context, those words such as “including” and “comprising” in the entire specification and the claims shall be interpreted as inclusive rather than exclusive or exhaustive, that is, as “including but not limited to”.

In the descriptions of the present disclosure, it should be understood that the terms such as “first” and “second” are used only for the purpose of descriptions rather than interpreted as indicating or implying relative importance. In addition, in the descriptions of the present disclosure, “plural” refers to two or more unless otherwise stated.

For the delivery mode based on delivery robot, a plurality of delivery robots are generally provided in a predetermined region (e.g. a community or a building), and an order delivery man only needs to place one or more orders into a storage bin of a delivery robot. After the storage bin becomes full, the delivery robot will immediately start delivery. When there is any vacant position in the storage bin, the delivery robot will wait for some time before starting delivery. Sometimes, there is a case that a delivery man arrives at a handover position shortly after all delivery robots starting delivery. At this time, the delivery man has to wait until at least one delivery robot returns to the handover position before handing over an order to be delivered to the delivery robot. As a result, the delivery man may wait for a long period of time at the handover position. In some cases, a delivery robot may have to wait for a long period of time before an elevator comes up during a delivery process or wait for a long period of time before a user picks up an order. In this case, unnecessary time wastes will be resulted, thereby adversely affecting the efficiency of the delivery process.

The following examples will be described with a predetermined region as a building and a delivery object of an order as a takeout. However, those skilled in the art may easily understand that the order-scheduling method in the examples is also applicable to other predetermined regions such as a community.

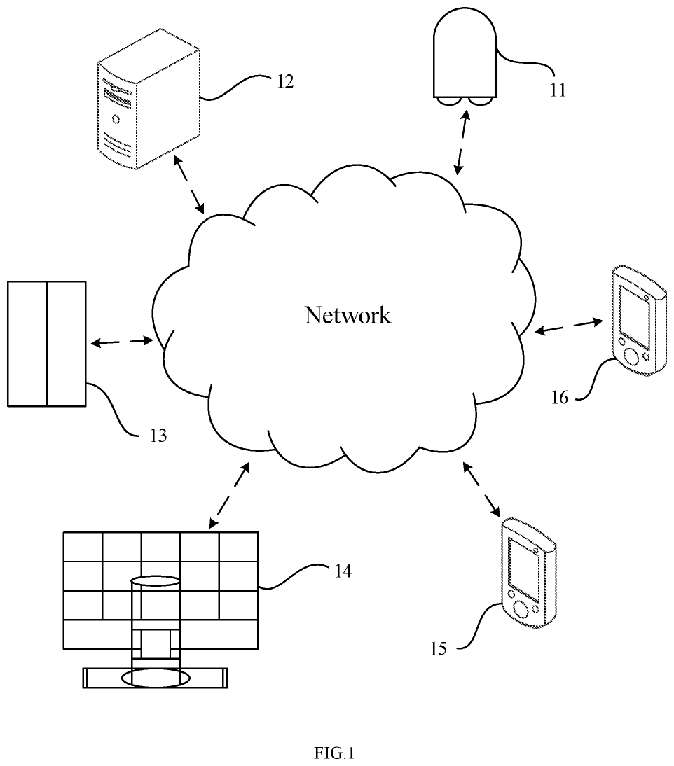

FIG. 1 is a diagram of a system architecture according to examples of the present disclosure. As shown in FIG. 1, the system architecture includes a delivery robot 11, a server 12, an elevator 13, a transfer system 14, a first terminal 15 and a second terminal 16. The delivery robot 11, the server 12, the elevator 13, the transfer system 14, the first terminal 15 and the second terminal 16 may communicate with each other through a network. The server 12 is used to schedule an order so that a delivery man holding the first terminal 15 may hand over the order to the delivery robot 11 or the transfer system 14 according to the scheduling of the server 12. At the same time, the server 12 is also used to schedule the elevator 13 so that the delivery robot 11 may take the elevator 13 to deliver a delivery object according to the scheduling of the server 12. After arriving at a target address of the order, the delivery robot 11 may send a notification to the second terminal 16 corresponding to the order so that a user holding the second terminal 16 may pick up the delivery object of the order according to the notification.

It shall be understood that in the examples of the present disclosure, the order is order-related information such as an order identifier and a target address of an order, and the delivery object is a real object of an order.

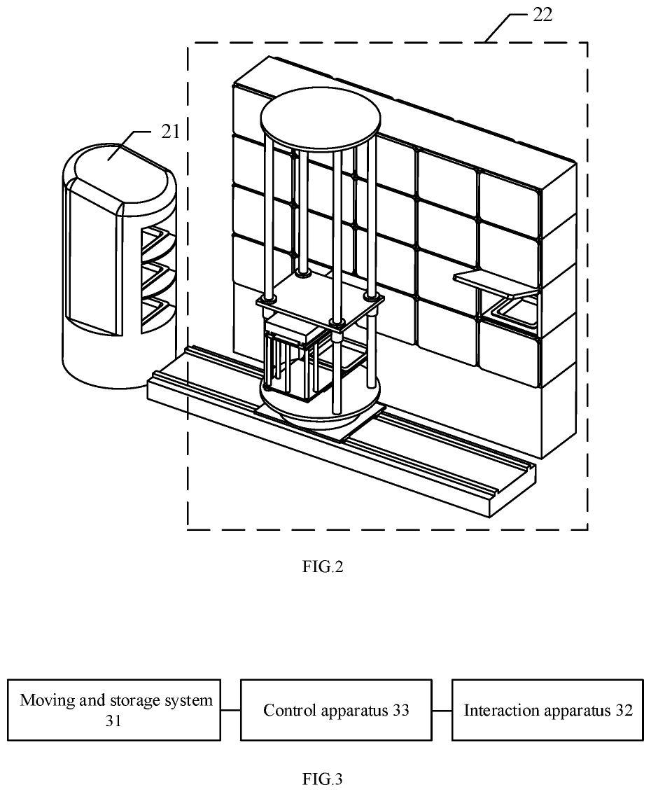

FIG. 2 is a schematic diagram of an automatic delivery system according to a first example of the present disclosure. As shown in FIG. 2, the automatic delivery system in this example includes a delivery robot 21 and a transfer system 22. A position where the delivery robot 21 is located is a handover-for-transfer position of the transfer system 22. The delivery robot 21 performs information interaction with the transfer system 22 so that the delivery robot 21 may hand over a delivery object to the transfer system 22 for transfer or transfer a delivery object out of the transfer system 22 for delivery.

FIG. 3 is a structural block diagram of a delivery robot according to a second example of the present disclosure. As shown in FIG. 3, the delivery robot in this example includes a moving and storage system 31, an interaction apparatus 32 and a control apparatus 33. The moving and storage system 31 is configured to drive the delivery robot to move and be controlled to open or close at least one storage bin for taking or placing a delivery object. The interaction apparatus 32 is configured to perform information interaction. The control apparatus 33 is configured to control the moving and storage system to move to the handover-for-transfer position corresponding to the order for transferring the delivery object or move to the target address of the order for direct delivery of the delivery object.

When used to drive the delivery robot to move, the moving and storage system 31 may include a drive apparatus (e.g. a stepping motor, a servo motor or the like), a driving wheel and a driven wheel and the like, and may also include other apparatuses based on the actual requirements, such as a detection apparatus for detecting a speed and an acceleration and so on of the delivery robot and the like. When used to control the opening and closing of a bin door of the delivery robot, the moving and storage system 31 may include a bin-door-controlling apparatus which is used to control the bin door to open and close according to the type of the bin door. For example, if the bin door is an electromagnetic door, the bin-door-controlling apparatus may control the bin door to open and close by changing electromagnetic field strength. The interaction apparatus 32 may interact with the server, the first terminal, the second terminal, and the transfer system to receive or send information. The control apparatus 33 is used to control a movement path of the delivery robot, specifically, control the moving and storage system 31 to move to the handover-for-transfer position corresponding to the order for transferring the delivery object or move to the target address of the order for direct delivery of the delivery object.

In a first possible case of the example, when it is not convenient for a user to pick up a meal, the user may send a transfer instruction to the delivery robot by the second terminal. It should be understood that the server may also send a transfer instruction to the control apparatus 33 of the delivery robot in a case of a larger number of orders. After receiving the transfer instruction, the control apparatus 33 may control the moving and storage system 31 to move the delivery robot to the handover-for-transfer position for transferring the delivery object. As a result, the user may take the delivery object of the order at convenient time. The transfer instruction may include an identifier of an order for transfer, a target address of an order, and a location of a transfer system corresponding to an order, and the control apparatus 33 may control the delivery robot to transfer the delivery object to a corresponding transfer system according to the transfer instruction.

After successfully handing over the delivery object to the transfer system, the delivery robot may further obtain an identifier of a storage bin in the transfer system and corresponding to the delivery object and send a notification to a corresponding second terminal. In this way, the user may pick up the delivery object of the order according to the notification. The interaction apparatus 32 may send a text message notification to a terminal corresponding to the order, or send a network notification to the terminal corresponding to the order. It shall be understood that the interaction apparatus is not limited to notifying a user in the above manners, and may alternatively notify the terminal corresponding to the order by telephone. At the same time, status information of the order may be updated and then sent to the server via the interaction apparatus 32 to inform the server that the delivery of the corresponding delivery object is finished.

For example, the delivery robot 1 receives a transfer instruction of an order 1 and hands over the order 1 to a transfer system of the 3rd floor (i.e. the floor where the target address of the order 1 is located). After handover finished, the delivery robot 1 obtains an identifier of a storage bin for the order 1 and in the transfer system is storage bin 1 and thus may send the second terminal of the user 1 a notification indicating that “the order 1 is stored in the storage bin 1 in the transfer system of the 3rd floor and please take your meal in time”. In this case, the user 1 may pick up the takeout of the order 1 based on the notification.

In a second possible case of the example, when an order queue allocated to the delivery robot satisfies a preset condition, the control apparatus 33 may control the moving and storage system 31 to move the delivery robot to the handover-for-transer position for transferring a delivery object. The preset condition may be that a length of the order queue exceeds a first threshold. When the length of the order queue exceeds the first threshold, it indicates that there are a larger number of orders to be delivered. If the orders are delivered to the target addresses, part of the orders may be delayed, thus reducing the satisfaction of the users. Therefore, the control apparatus 33 may control the delivery robot to transfer one or more delivery objects to corresponding transfer systems and send notifications to corresponding second terminals, so that the users may pick up the delivery objects by themselves according to the notifications.

It should be understood that in the second possible case, the implementation manner in which the control apparatus 33 hands over the delivery object to the transfer system and subsequently performs interaction via the interaction apparatus 32 is similar to the implementation manner in the first possible case and thus will not be repeated herein.

In the first and second possible cases of the example, the control apparatus 33 may control the moving and storage system 31 to move to the handover-for-transfer position for transferring the delivery object. Specifically, the control apparatus 33 may send a second placing instruction to the transfer system through the interaction apparatus 32 after controlling the moving and storage system 31 to move to the handover-for-transfer position. Therefore, the delivery robot may hand over the delivery object to the transfer system for transfer.

In a third possible case of the example, when all delivery robots are in delivery state or there are a larger number of orders to be delivered or the second placing instruction is received from the server, the delivery man may hand over delivery objects of orders to the transfer systems. The control apparatus 33 may control the moving and storage system 31 to move to the handover-for-transfer position for receiving the delivery object and transferring the delivery object to the target address. After controlling the moving and storage system 31 to the handover-for-transfer position, the control apparatus 33 may send a second taking instruction to the transfer system through the interaction apparatus 32. After the delivery object corresponding to the second taking instruction is taken, the control apparatus 33 may control the delivery robot to transfer the delivery object to the target address. In this case, the delivery robot may take the delivery object from the transfer system and deliver the delivery object.

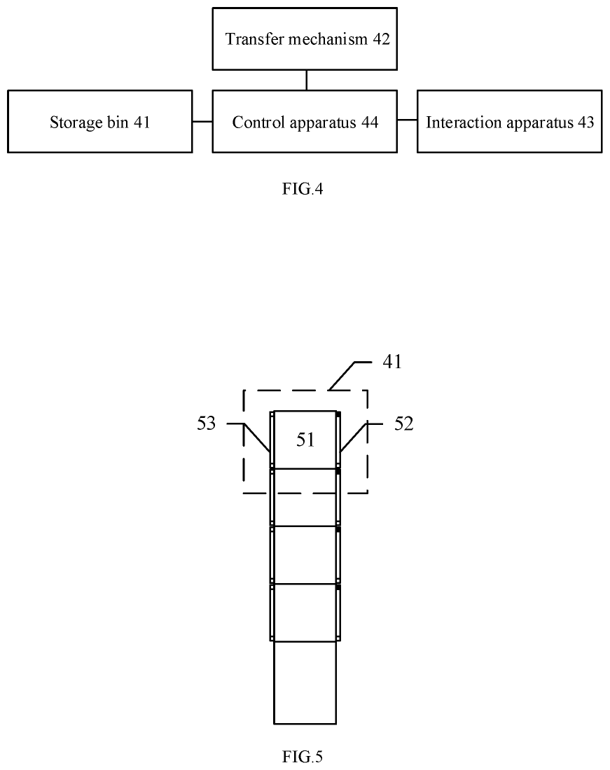

FIG. 4 is a schematic diagram of a transfer system according to a third example of the present disclosure. As shown in FIG. 4, the transfer system in this example includes at least one storage bin 41, a transfer mechanism 42, an interaction apparatus 43 and a control apparatus 44. FIG. 5 is a side view of a storage bin of a transfer system according to a third example of the present disclosure. As shown in FIG. 5, a dashed-line region shown in FIG. 5 is a storage bin 41 including a storage space 51 and a first unit door 52 and a second unit door 53 both closing the storage space, where the first unit door 52 and the second unit door 53 are oppositely disposed. The transfer mechanism 42 is disposed at a side of the storage bin where the second unit door 53 is provided and is configured to transfer a delivery object between the storage bin and the handover-for-transfer position as controlled. The interaction apparatus 43 is configured to receive and send an instruction. The control apparatus 44 is configured to control the first unit door 52 and the second unit door 53 of the storage bin 41 and the transfer mechanism 42. It shall be understood that the transfer system further includes at least one apparatus controlled to open the first unit door 52 and/or the second unit door 53, as well as at least one motor or controller for controlling a moving direction and a moving position of the transfer mechanism 42. As a result, the control apparatus is capable of controlling the at least one storage bin 41 and the transfer mechanism 42 by use of the controlled apparatus, the motor or the controller.

In a first possible case of the example, when an order queue satisfies a preset condition or a transfer instruction is received from the second terminal, the delivery robot may send a first placing instruction to the interaction apparatus 43 of the transfer system after arriving at the handover-for-transfer position. After the interaction apparatus 43 receives the first placing instruction, the control apparatus 44 may select one vacant storage bin 41, control the second unit door 53 of the storage bin 41 to open and control the transfer mechanism 42 to transfer the delivery object into the storage bin 1 from the handover-for-transfer position. The control apparatus 44 may also control the second unit door 53 of the storage bin 41 to close, for example, after a predetermined time length subsequent to opening of the second unit door 53 or after a second unit door closing instruction is received from the delivery robot, and send an identifier of the storage bin 41 to the delivery robot. Thus, the delivery robot may update the status information of the order according to the identifier of the storage bin 41 and notify the user of a storage position of the delivery object.

After receiving the notification from the delivery robot, the user may go to the handover-for-transfer position of the corresponding transfer system to take the delivery object. The second terminal may generate a first taking instruction according to the notification of the delivery robot. After arriving at the handover-for-transfer position, the user may send a first taking instruction to the interaction apparatus 43 through the second terminal. After the interaction apparatus 43 receives the first taking instruction, the control apparatus 44 may control the first unit door 52 of the storage bin 41 corresponding to the first taking instruction to open. As a result, the user may take the delivery object corresponding to the first taking instruction. The control apparatus 44 may also control the first unit door 52 to close, for example, after a predetermined time length subsequent to opening of the first unit door 52 or after a first unit door closing instruction is received from the second terminal.

For example, after receiving the notification from the delivery robot 1 (i.e. “the order 1 is stored in the storage bin 1 of the transfer system of the 3rd floor, and please take your meal in time”), the user 1 gets to the handover-for-transfer position of the transfer system of the 3rd floor and then sends the first taking instruction of the order 1 to the control apparatus of the transfer system of the 3rd floor. After receiving the first taking instruction of the order 1, the control apparatus controls the first unit door of the storage bin 1 to open. After taking meal, the user may send the first unit door closing instruction through the second terminal. Thus, the control apparatus may control the first unit door of the storage bin 1 to close.

In a second possible case of the example, when all delivery robots are in delivery state or there are a larger number of orders or the second placing instruction is received from the server, the delivery man may hand over one or more delivery objects of orders to the transfer systems. The delivery man sends the second placing instruction to the interaction apparatus 43 of the transfer system through the first terminal at the handover-for-transfer position. After the interaction apparatus 43 receives the second placing instruction, the control apparatus 44 selects one vacant storage bin 41 and controls the first unit door 52 of the storage bin 41 to open. Thus, the delivery man may place the delivery object corresponding to the second placing instruction into the storage space 51 of the storage bin 41. The control apparatus 44 may also control the first unit door 52 to close, for example, after a predetermined time length subsequent to opening of the first unit door 52 or after the first unit door closing instruction is received from the first terminal.

After placing the delivery object into the storage bin 41 of the transfer system, the delivery man may send updated status information to the server to notify the server that placing of the delivery object has been finished. Therefore, the delivery robot may obtain the storage position of the order according to the information of the order and get to the corresponding transfer system to receive the delivery object. After arriving at the handover-for-transfer position of the corresponding transfer system, the delivery robot may send the second taking instruction to the interaction apparatus 43. After the interaction apparatus 43 receives the second taking instruction, the control apparatus 44 may control the second unit door 53 of the storage bin 41 corresponding to the second taking instruction to open, and control the transfer mechanism 42 to take the delivery object out of the storage bin 41 and transfer the delivery object to the handover-for-transfer position. In this way, the delivery robot may receive the delivery object and start delivery. The control apparatus 44 may also control the second unit door 53 to close, for example, after a predetermined time length subsequent to opening of the second unit door 53 or after a second unit door closing instruction is received from the delivery robot.

In this example, the interaction apparatus 43 may interact with the delivery robot, the first terminal and the second terminal by wireless communication or by scanning a computer-recognizable pattern (e.g. a QR code, or a barcode or the like).

FIG. 6 is a schematic diagram of a transfer apparatus according to a third example of the present disclosure. As shown in FIG. 6, the transfer apparatus in this example includes a base 61, a rotary seat 62, a lifting apparatus 63, first shafts 64, a retractable apparatus 65 and a taking-and-placing component 66. The base 61 is provided with a guiderail extending along a first direction (i.e. a direction of the dashed line L1) to the handover-for-transfer position (i.e. the position shown by 6A in FIG. 6). The rotary seat 62 is disposed on the base 61 and configured to move along the first direction on the guiderail and rotate with a second direction (i.e. the direction of the dashed line L2) as an axial direction. The first shafts 64 are disposed on the rotary seat 62. The lifting apparatus 63 is disposed above the rotary seat 62 and on the first shafts 64, and configured to move along a third direction (i.e. the direction of the dashed line L3) on the first shafts 64. The retractable apparatus 65 is disposed on the lifting apparatus 63 and configured to move along a fourth direction (i.e. the direction of the dashed line L4). The taking-and-placing component 66 is connected to the retractable apparatus 65 to perform taking and placing operations along with the movement of the retractable apparatus 65. The transfer system may further include a tray 67 which is placed in the storage bin. Therefore, the transfer mechanism is only to perform operations to the tray 67 when placing a delivery object into the storage bin or taking the delivery object out of the storage bin. The taking-and-placing component 66 further includes an operating arm 661 for taking and placing the tray 67. The transfer mechanism further includes a first motor for independently controlling the rotary seat 62 to move along the first direction, a second motor for independently controlling the rotary seat 62 to rotate with the second direction as the axial direction, a third motor for independently controlling the lifting apparatus 63 to move along the third direction, and a fourth motor for independently controlling the retractable apparatus 65 to move along the fourth direction. Therefore, the control apparatus of the transfer system may control the rotary seat 62, the lifting apparatus 63, the retractable apparatus 65 and the taking-and-placing component 66 through various motors according to the position of the storage bin, thereby placing and taking the delivery object.

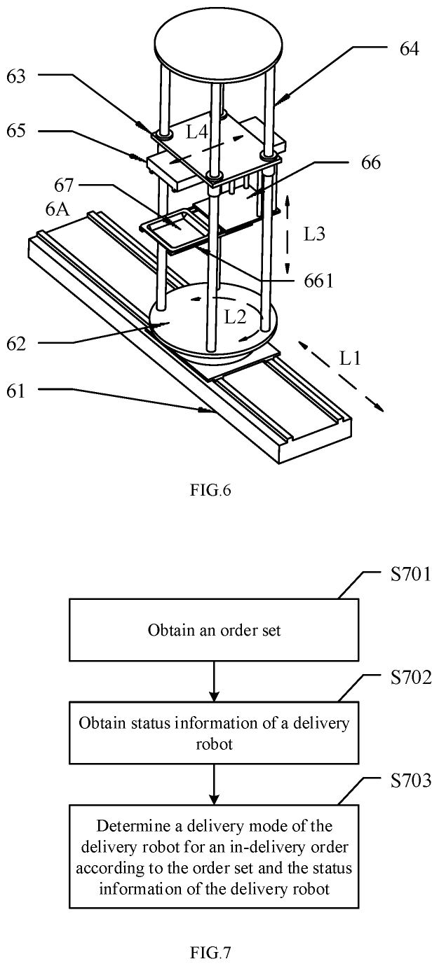

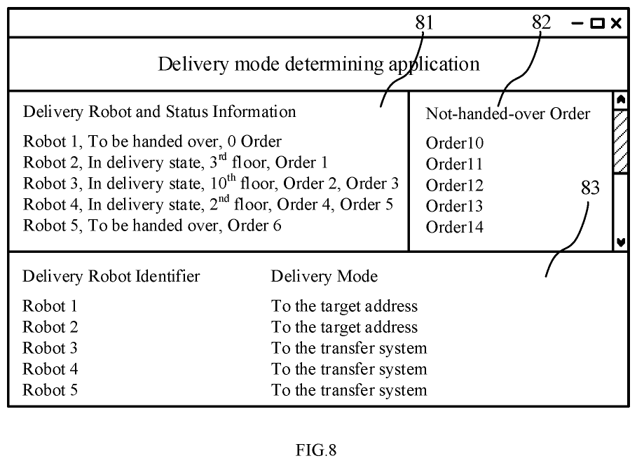

FIG. 7 is a flowchart of an order delivery method according to a fourth example of the present disclosure. The order delivery method in this example is applied to a server. As shown in FIG. 7, the order delivery method in this example includes the following steps.

At step S701, an order set is obtained.

A target address of each order in the order set is within a predetermined region, and the each order in the order set is an order to be handed over to an automatic delivery system.

At step S702, status information of a delivery robot is obtained.

The status information of the delivery robot includes an in-delivery order and a current position of the delivery robot. The delivery robot may determine its own current status information and report the status information to a server through a network. As a result, the server may obtain the status information of the delivery robot.

It should be understood that steps S701 and S702 can be performed simultaneously or one after another. Therefore, it is not necessary to specify the sequence of the two steps.

At step S703, a delivery mode of the delivery robot for the in-delivery order is determined according to the order set and the status information of the delivery robot.

The delivery mode includes transferring a delivery object through a transfer system or moving to the target address of the order for direct delivery. The delivery mode of the delivery robot for the one or more in-delivery orders is determined by the server according to the order set, the target positions of the one or more in-delivery orders and the current position of the delivery robot. When there are a plurality of delivery robots within the predetermined region, for each delivery robot, the server may determine the delivery mode for the in-delivery order according to the current position of each robot and the in-delivery order and the current position of the delivery robot.

For example, when a number of orders in the order set or a number of the in-delivery orders exceeds a second threshold and all delivery robots are in delivery state, the delivery mode of all delivery robots may be determined as transferring delivery objects through the transfer systems, and a transfer instruction is sent to all delivery robots to cause all delivery robots to handing over the delivery objects to the transfer systems. When the number of orders in the order set or the number of the in-delivery orders does not exceed the second threshold or there is at least one delivery robot in a to-be-handed-over state, the delivery mode of part of the delivery robots may be determined as transferring the delivery object through the transfer system and a transfer instruction is sent to the corresponding delivery robots to cause the corresponding delivery robots to handing over the delivery objects to the transfer systems; and the delivery mode of other delivery robots may be determined as moving to the target address of the order for direct delivery of the delivery object. When neither of the number of orders in the order set and the number of orders in a second order set exceeds the second threshold and there is at least one delivery robot in a to-be-handed-over state, the delivery mode of all delivery robots may be determined as moving to the target address of the order for direct delivery of the delivery object.

It should be understood that the delivery mode of the delivery robot for the in-delivery order may also be determined according to the target positions of orders in the order set, the target positions of the in-delivery orders, and the current position of the delivery robot.

In this example, the order set and the status information of the delivery robot are obtained, and then the delivery mode of the delivery robot for the in-delivery order is determined according to the order set and the status information of the delivery robot. In this way, the efficiency of the delivery process is improved and the delivery costs of the delivery robot are reduced.

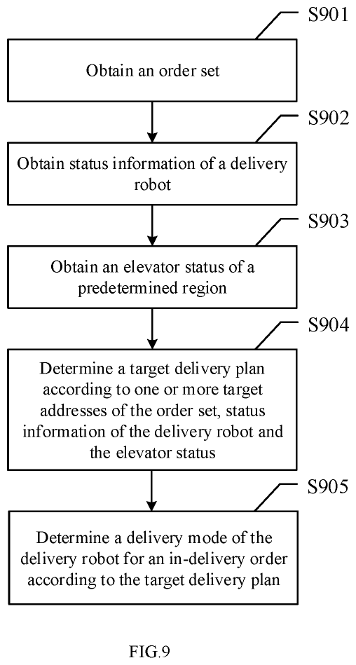

FIG. 8 is a schematic diagram of an interface according to a fourth example of the present disclosure. As shown in FIG. 8, in a building there are five delivery robots, which are robot 1, robot 2, robot 3, robot 4 and robot 5, respectively. A server may obtain status information of the five delivery robots and display the status information in a delivery robot information display window 81. At the same time, the server may obtain information of one or more orders which are not handed over to an automatic delivery system with a target address in the building (i.e. a second order set) and display the information in a not-handed-over order display window 82. It should be understood that the not-handed-over order display window 82 may display identifiers of one or more orders in the second order set and may also display other information, such as target addresses of orders and the like. After determining the delivery mode of each delivery robot, the server may display the delivery modes in a delivery mode result display window 83. The server may further send a transfer instruction to robot 3, robot 4 and robot 5. As a result, robot 3, robot 4 and robot 5 may hand over the delivery objects to a transfer system so that the delivery objects of order 2, order 3, order 4, order 5 and order 6 can be transferred.

FIG. 9 is a flowchart of an order delivery method according to a fifth example of the present disclosure. The order delivery method in this example is applied to a server. As shown in FIG. 9, the order delivery method in this example includes the following steps.

At step S901, an order set is obtained.

In this example, step S901 is similar to step S701 in implementation and thus will not be repeated herein.

At step S902, status information of a delivery robot is obtained.

In this example, step S902 is similar to step S702 in implementation and thus will not be repeated herein.

It should be understood that steps S901 and S902 may be performed simultaneously or one after another. Therefore, it is not necessary to specify a sequence of the two steps.

At step S903, an elevator status of a predetermined region is obtained.

The elevator status may include a current position of an elevator and a running direction of the elevator. It should be understood that the elevator status is not limited to the above two kinds of information and may further include an acceleration of the elevator obtained by an accelerometer and the like.

It should be understood that steps S902 and S903 may be performed simultaneously or one after another. Therefore, it is not necessary to specify a sequence of the above two steps.

At step S904, a target delivery plan is determined according to target addresses of the order set, the status information of the delivery robot and the elevator status.

The server may determine the target delivery plan according to the target addresses of the order set, a target address of an in-delivery order and a current position of the delivery robot.

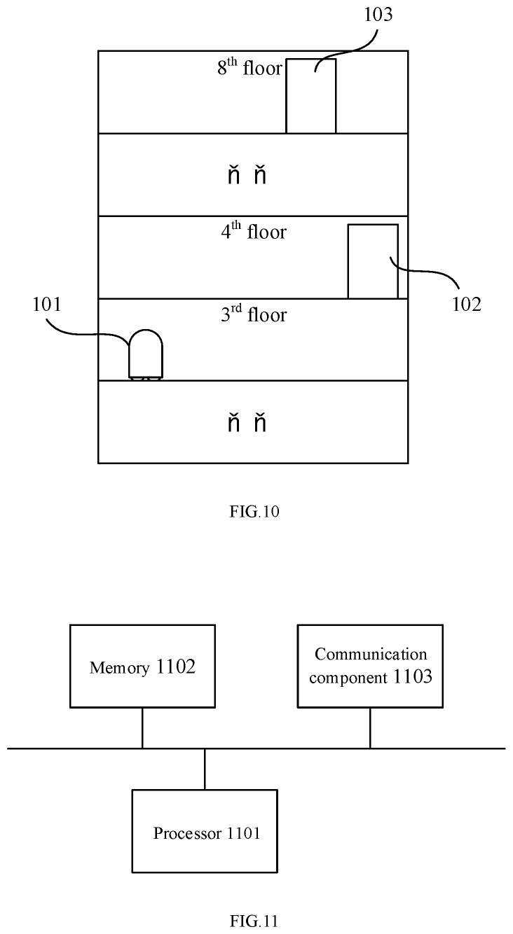

FIG. 10 is a diagram of an application scenario according to a fifth example of the present disclosure. As shown in FIG. 10, there is one delivery robot denoted as robot 101 in a building. The robot 101 is in a delivery state and is currently located at the 3rd floor, a to-be-delivered order (i.e. a first order) denoted as an order 1 is stored in a bin, and the target address of the order 1 is at the 8th floor. The building includes two elevators which are elevator 102 and elevator 103, respectively, where the elevator 102 stays at the 4th floor and the elevator 103 stays at the 8th floor. During the delivery process of the robot 101, a number of orders in the second order sets exceeds 10, and the second order set includes a plurality of orders with their target addresses being at the 5th floor, which are order 2, order 3 and order 4 respectively. As a result, the server may determine a current target delivery plan of the robot 101 as follows: taking the elevator 102 to arrive at the 8th floor to deliver the delivery object of the order 1, and taking the elevator 103 to return to a handover position in the building. The server may also schedule order 2, order 3 and order 4 to the robot 101 at the same time. Thus, the robot 101 may efficiently complete delivery of the delivery objects of order 2, order 3 and order 4 subsequently.

Optionally, in the example, the status information of the delivery robot may also include a number of current vacant bins, and the elevator status includes a current position of an elevator, a number of floors where the elevator is to stay, one or more floors where the elevator is to stay and a running status. Therefore, the server may determine the target delivery plan according to the target addresses of the in-delivery orders, the target addresses of the order set, the status information of the delivery robot, the current position of the elevator, the number of floors where the elevator is to stay, the one or more floors where the elevator is to stay and the running status.

For example, when the robot 1 arrives at the 5th floor to deliver order 1 and is to get to the 8th floor by elevator to deliver order 2, the elevator 1 is currently at the 2nd floor with its running direction upward, and the floors where the robot 1 is to stay are the 5th floor and the 7th floor. In this case, the server may determine the target delivery plan of order 1 as follows: handing over the order 1 to the transfer system of the 5th floor, and getting to the 8th floor by elevator to deliver order 2. The server may also determine the delivery plan of order 2 so as to determine the delivery plan of robot 1.

At step S905, the delivery mode of the delivery robot for an in-delivery order is determined according to the target delivery plan.

The server may determine the delivery mode of the delivery robot 101 according to the target delivery plan of the robot 101 as follows: handing over the delivery object of order 1 to the transfer system of the 8th floor. As a result, the robot 101 can quickly complete the transfer of the order 1. In this way, the robot 101 can obtain order 2, order 3 and order 4 and take elevator 103 to deliver the delivery objects of order 2, order 3 and order 4.

In this example, the order set and the status information of the delivery robot are obtained, and then the delivery mode of the delivery robot for the in-delivery order is determined according to the order set and the status information of the delivery robot. In this way, a time for the delivery robot to wait for elevator is reduced, thereby further improving the efficiency of the delivery process and reducing the delivery costs of the delivery robot.

FIG. 11 is a schematic diagram of an electronic device according to a fifth example of the present disclosure. In this example, the electronic device is a server. In some cases, the electronic device may be another electronic device such as Raspberry Pi. As shown in FIG. 11, the electronic device may include at least one processor 1101, a memory 1102 in communication with the at least one processor 1101, and a communication component 1103 in communication with a scanning device. The communication component 1103 is controlled by the processor 1101 to receive and send data. The memory 1102 stores instructions executable by the at least one processor 1101. The instructions are executed by the at least one processor 1101 to perform the following operations:

obtaining an order set, where a target address of each order in the order set is within a predetermined region, and the order is an order to be handed over to an automatic delivery system;

obtaining status information of a delivery robot, where the status information of the delivery robot includes an in-delivery order and a current position of the delivery robot;

determining a delivery mode of the delivery robot for the in-delivery order according to the order set and the status information of the delivery robot, where the delivery mode includes transferring a delivery object through a transfer system, or moving to the target address of the order for direct delivery.

Further, determining the delivery mode of the delivery robot for the in-delivery order according to the order set and the status information of the delivery robot includes:

determining the delivery mode of each delivery robot for the in-delivery order according to the order set and the status information of each delivery robot.

Further, the electronic device may be configured to perform the following steps:

obtaining an elevator status of the predetermined region; and

determining the delivery mode of the delivery robot for the in-delivery order according to the order set and the status information of the delivery robot, including:

determining a target delivery plan according to the target address of the in-delivery order, the one or more target addresses of the order set, the status information of the delivery robot, and the elevator status; and

determining the delivery mode of the delivery robot for the in-delivery order according to the target delivery plan.

Further, the status information of the delivery robot further includes a number of current vacant bins, and the elevator status includes a current position of an elevator, a number of floors where the elevator is to stay, one or more floors where the elevator is to stay and a running status.

Determining the target delivery plan according to the target address of the in-delivery order, the one or more target addresses of the order set, the status information of the delivery robot and the elevator status includes:

determining the target delivery plan according to the target address of the in-delivery order, the one or more target addresses of the order set, the status information of the delivery robot, the current position of the elevator, the number of the floors where the elevator is to stay, the one or more floors where the elevator is to stay and the running status.

The electronic device further includes one or more processors 1101 and a memory 1102. FIG. 11 illustrates one processor 1101 as an example. The processor 1101 and the memory 1102 may be connected through a bus or in another manner. FIG. 11 illustrates bus connection as an example. The memory 1102, as a non-volatile computer readable storage medium, is used to store non-volatile software programs, non-volatile computer-executable programs and modules. The processor 1101 performs various applications and data processing of the electronic device, that is, realize the above order delivery method, by running the non-volatile software programs, the instructions and the modules stored in the memory 1102.

The memory 1102 includes a program-storing zone and a data-storing zone, where the program-storing zone stores an operating system, an application needed by at least one function, and the data-storing zone stores an option list and the like. Further, the memory 1102 includes a high-speed random access memory and may further include a non-volatile memory, for example, at least one disk storage device, flash memory device, or another non-volatile solid-state storage device. In some examples, the memory 1102 optionally includes memories remotely set relative to the processor 1101, and these remote memories are connected to an external device through a network. The network in the above examples includes but is not limited to internet, enterprise intranet, local area network, mobile communication network and a combination thereof.

One or more modules are stored in the memory 1102 and executed by the one or more processors 1101 to perform the order delivery method in the any above method example.

The above product can perform the method of the examples of the present disclosure and has functional modules and beneficial effects corresponding to the method implementation. Those technical details not described in the example can be seen in the method of the examples of the present disclosure.

In this example, the order set and the status information of the delivery robot are obtained, and then the delivery mode of the delivery robot for the in-delivery order is determined according to the order set and the status information of the delivery robot. In this way, time for the delivery robot to wait for an elevator is reduced, which improves the efficiency of the delivery process and reduces the delivery costs of the delivery robot.

A sixth example of the present disclosure relates to a non-volatile storage medium storing computer-readable programs which are used for a computer to perform all or part of the method in the above examples.

Those skilled in the art may understand that all or part of the method in the above examples may be carried out by instructing relevant hardware using programs. The programs are stored in one storage medium and include one or more instructions for making a device (a single-chip computer, a chip or the like) or processor to perform all or part of the method in various examples in the present disclosure. The above storage medium includes U-drive, removable hard disk, Read-Only Memory (ROM), Random Access Memory (RAM), diskette, compact disk or other mediums storing program codes.

Those skilled in the art should understand that the above examples are specific examples of the present disclosure and may be changed in form or details in actual applications without departing from the spirit and scope of the present disclosure.

1. (canceled)

2. (canceled)

3. (canceled)

4. (canceled)

5. (canceled)

6. An electronic device, comprising a memory and a processor, wherein the memory is configured to store one or more computer program instructions, and the one or more computer program instructions are executed by the processor to perform the following steps:
obtaining an order set, wherein a target address of each order in the order set is within a predetermined region, and the order is an order to be handed over to an automatic delivery system;
obtaining status information of a delivery robot, wherein the status information of the delivery robot comprises an in-delivery order and a current position of the delivery robot;
determining a delivery mode of the delivery robot for the in-delivery order according to the order set and the status information of the delivery robot, wherein the delivery mode comprises transferring a delivery object through a transfer system, or moving to the target address of the order for direct delivery.

7. The electronic device according to claim 6, wherein when a number of the delivery robots in the predetermined region is greater than one, determining the delivery mode of the delivery robot for the in-delivery order according to the order set and the status information of the delivery robot comprises:
determining the delivery mode of each delivery robot for the in-delivery order according to the order set and the status information of each delivery robot.

8. The electronic device according to claim 6, further configured to perform following steps:
obtaining an elevator status of the predetermined region; and
determining the delivery mode of the delivery robot for the in-delivery order according to the order set and the status information of the delivery robot, comprising:
determining a target delivery plan according to the target address of the in-delivery order, one or more target addresses of the order set, the status information of the delivery robot and the elevator status; and
determining the delivery mode of the delivery robot for the in-delivery order according to the target delivery plan.

9. The electronic device according to claim 8, wherein the status information of the delivery robot further comprises a number of current vacant bins, and the elevator status comprises a current position of an elevator, a number of floors where the elevator is to stay, one or more floors where the elevator is to stay and a running status;
determining the target delivery plan according to the target address of the in-delivery order, the one or more target addresses of the order set, the status information of the delivery robot and the elevator status comprises:
determining the target delivery plan according to the target address of the in-delivery order, the one or more target addresses of the order set, the status information of the delivery robot, the current position of the elevator, the number of floors where the elevator is to stay, the one or more floors where the elevator is to stay and the running status.

10. A delivery robot, comprising:
a moving and storage system, configured to drive the delivery robot to move and be controlled to open or close at least one storage bin for taking or placing a delivery object;
an interaction apparatus, configured to perform information interaction; and
a control apparatus, configured to control the moving and storage system to move to a handover-for-transfer position corresponding to an order for transferring a delivery object, or move to a target address of the order for direct delivery of the delivery object.

11. The delivery robot according to claim 10, wherein the control apparatus is configured to control the moving and storage system to move to the handover-for-transfer position for transferring the delivery object in response to receiving a transfer instruction.

12. The delivery robot according to claim 10, wherein the control apparatus is configured to control the moving and storage system to move to the handover-for-transfer position for transferring the delivery object in response to that an allocated order queue satisfies a preset condition.

13. The delivery robot according to claim 12, wherein the preset condition is that a length of the order queue exceeds a first threshold.

14. A transfer system, comprising:
at least one storage bin, wherein the at least one storage bin each comprises a storage space, a first unit door and a second unit door both closing the storage space, and the first unit door and the second unit door are oppositely disposed;
a transfer mechanism, disposed at a side of the at least one storage bin on which the second unit door is provided, and configured to be controlled to transfer a delivery object between the at least one storage bin and a handover-for-transfer position;
an interaction apparatus, configured to receive and send an instruction;
a control apparatus, configured to control the first unit door and the second unit door of the at least one storage bin and the transfer mechanism;
wherein the control apparatus is configured to, in response to that the interaction apparatus receives a first placing instruction, select one vacant storage bin, control the second unit door of the vacant storage bin to open, and control the transfer mechanism to transfer the delivery object into the storage bin from the handover-for-transfer position.

15. The transfer system according to claim 14, wherein the transfer mechanism comprises:
a base, provided with a guiderail extending along a first direction to the handover-for-transfer position;
a rotary seat, disposed on one or more first shafts and configured to move along the first direction on the guiderail and rotate with a second direction as an axial direction;
a lifting apparatus, disposed above the rotary seat and on the one or more first shafts and configured to move along a third direction on the one or more first shafts;
a retractable apparatus, disposed on the lifting apparatus and configured to move along a fourth direction;
a taking-and-placing component, connected to the retractable apparatus to perform taking or placing operations along with movement of the retractable apparatus.

16. The transfer system according to claim 15, further comprising a tray that is disposed in the storage bin;
wherein the taking-and-placing component comprises an operation arm for taking and placing the tray.

17. The transfer system according to claim 14, wherein the control apparatus is configured to control a first unit door of a storage bin corresponding to a first taking instruction to open in response to that the interaction apparatus receives the first taking instruction.

18. The transfer system according to claim 14, wherein the control apparatus is configured to select one vacant storage bin and control a first unit door of the vacant storage bin to open in response to a second placing instruction.

19. The transfer system according to claim 18, wherein the control apparatus is configured to, in response to that the interaction apparatus receives a second taking instruction, control a second unit door of a storage bin corresponding to the second taking instruction to open and control the transfer mechanism to take the delivery object out of the storage bin and transfer the delivery object to the handover-for-transfer position.

20. The transfer system according to claim 14, wherein the interaction apparatus performs interaction through wireless communication and/or by scanning a computer-recognizable pattern.
